(19) United States
(12) Patent Application Publication
(10) Pub. No.: US 2010/0047515 A1
(43) Pub. Date: Feb. 25, 2010

(54) Honeycomb Core Having a High Compression Strength and Articles Made from the Same

(75) Inventors: RAINER KEHRLE, Stuttgart (DE); YVES KLETT, Dauchingen (DE); MIKHAIL R. LEVIT, Glen Allen, VA (US); OLIVIER LENGWILER, Vich (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/542,772

(22) Filed: Aug. 18, 2009

Related U.S. Application Data
(60) Provisional application No. 61/189,621, filed on Aug. 21, 2008.

(51) Int. Cl. B32B 3/12

(52) U.S. Cl. 428/116

(57) ABSTRACT

This invention is directed to a honeycomb core structure having a high compression modulus. The core structure comprises (a) a plurality of interconnected walls having surfaces which define a plurality of honeycomb cells, wherein the cell walls are formed from a nonwoven sheet and (b) a cured resin in an amount such that the weight of cured resin as a percentage of combined weight of cured resin and nonwoven sheet is at least 62 percent. The nonwoven sheet further comprises fibers having a modulus of at least 200 grams per denier (180 grams per dtex) and a tenacity of at least 10 grams per denier (9 grams per dtex) wherein, prior to impregnating with the resin, the nonwoven sheet has an apparent density calculated from the equation Dp=K×((dr×(100−% r)/% r)/(1+dr/ds×(100−% r)/% r), where Dp is the apparent density of the sheet before impregnation, dr is the density of cured resin, ds is the density of solid material in the sheet before impregnation, % r is the cured resin content in the final core structure in weight %, K is a number with a value from 1.0 to 1.5. Further, the Gurley porosity of the nonwoven sheet before impregnation with the resin is no greater than 30 seconds per 100 milliliters. The invention is also directed to composite structures incorporating such folded core.

### BACKGROUND OF THE INVENTION

1. Field of the Invention

This invention relates to a high compression strength honeycomb core structure made from a fibrous nonwoven sheet.

2. Description of Related Art

Core structures for sandwich panels from high modulus high strength fiber nonwoven sheets, mostly in the form of honeycomb, are used in different applications but primarily in the aerospace industry where strength to weight or stiffness to weight ratios have very high values. For example, U.S. Pat. No. 5,137,768 to Lin describes a honeycomb core made from a high-density wet-laid nonwoven comprising 50 wt. % or more of p-aramid fiber with the rest of the composition being a binder and other additives.

A commercially available p-aramid high modulus high strength fiber nonwoven sheet for the production of core structures is KEVLAR® N636 paper sold by E. I. DuPont de Nemours and Company, Wilmington, Del. The paper density for the lightest grade (1.4N636) ranges from 0.68 to 0.82 g/cm³. For three other grades (1.8N636, 2.8N636, and 3.9N636) the density range is from 0.78 to 0.92 g/cm³.

There are some applications, in which enhancement of compression properties is very important. This is particularly true for sandwich panels used in flooring for aircraft, trains, etc. Potentially, a honeycomb core optimized for compression strength can provide additional weight and cost savings. Therefore what is needed is a honeycomb core structure with improved compression strength.

### BRIEF SUMMARY OF THE INVENTION

This invention is directed to a honeycomb core structure having a high compression strength made from a fibrous nonwoven sheet. The cell walls of the honeycomb core structure comprise a nonwoven sheet and a cured resin in an amount such that the weight of cured resin as a percentage of combined weight of cured resin and nonwoven sheet is at least 62 percent. The nonwoven sheet further comprises fibers having a modulus of at least 200 grams per denier (180 grams per dtex) and a tenacity of at least 10 grams per denier (9 grams per dtex) wherein, prior to impregnating with resin, the nonwoven sheet has an apparent density calculated from the equation Dp=K×((dr×(100−% r)/% r)/(1+dr/ds×(100−% r)/% r), where Dp is the apparent density of the sheet before impregnation, dr is the density of cured resin, ds is the density of solid material in the sheet before impregnation, % r is the cured resin content in the final core structure in weight %, K is a number with a value from 1.0 to 1.35. Further, the Gurley porosity of the nonwoven sheet before impregnation with the resin is no greater than 30 seconds per 100 milliliters.

The invention is further directed to a composite panel containing a honeycomb core structure.

### BRIEF DESCRIPTION OF THE DRAWINGS

FIGS. 1a and 1b are representations of views of a hexagonal shaped honeycomb.

FIG. 2 is a representation of another view of a hexagonal cell shaped honeycomb.

FIG. 3 is an illustration of honeycomb provided with facesheet(s).

### DETAILED DESCRIPTION OF THE INVENTION

This invention is directed to a honeycomb core structure of high compression strength having cell walls made from a fibrous nonwoven sheet impregnated with a resin.

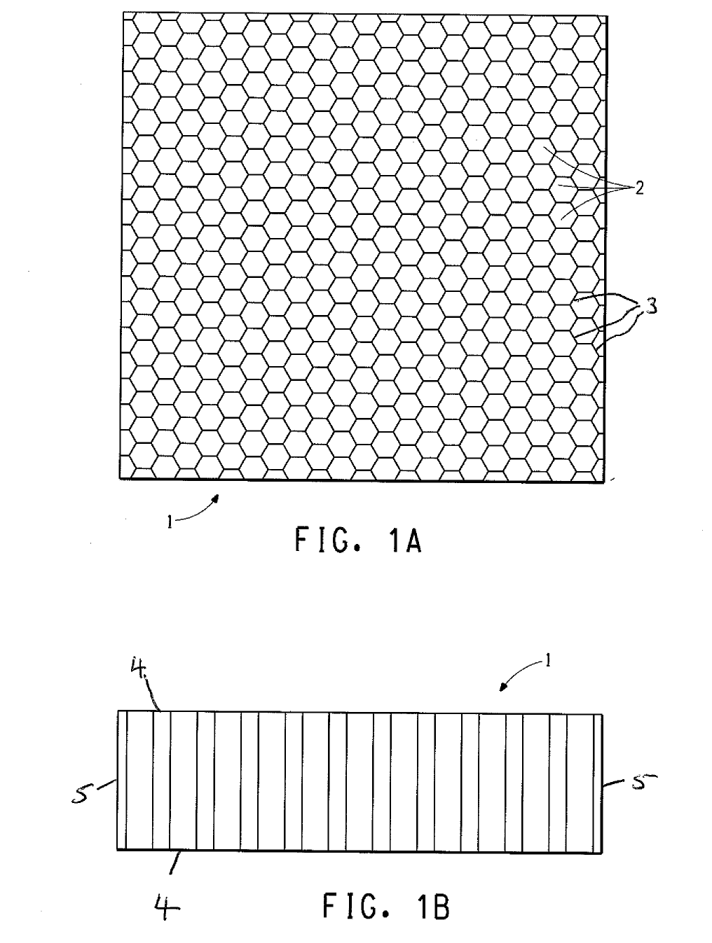

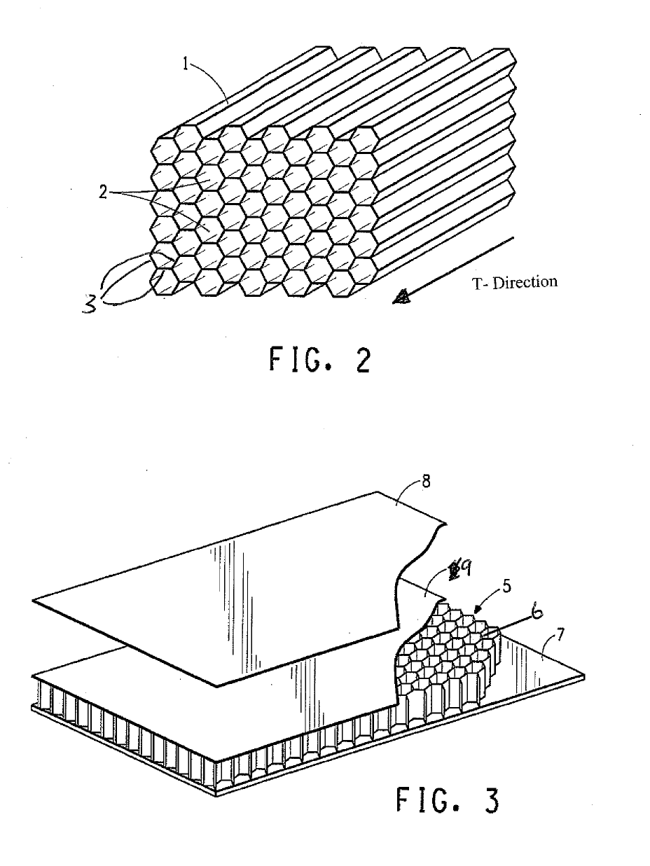

FIG. 1a is a plan view illustration of one honeycomb 1 of this invention and shows cells 2 formed by cell walls 3. FIG. 1b is an elevation view of the honeycomb shown in FIG. 1a and shows the two exterior surfaces, or faces 4 formed at both ends of the cell walls. The core also has edges 5. FIG. 2 is a three-dimensional view of the honeycomb. Shown is honeycomb 1 having hexagonal cells 2 and cell walls 3. The “T” dimension or the thickness of the honeycomb is shown in FIG. 2. Hexagonal cells are shown; however, other geometric arrangements are possible with square, over-expanded and flex-core cells being among the most common possible arrangements. Such cell types are well known in the art and reference can be made to Honeycomb Technology by T. Bitzer (Chapman & Hall, publishers, 1997) for additional information on possible geometric cell types.

FIG. 3 shows a structural sandwich panel 5 assembled from a honeycomb core 6 with face sheets 7 and 8, attached to the two exterior surfaces of the core. The preferred face sheet material is a prepreg, a fibrous sheet impregnated with thermoset or thermoplastic resin although metallic face sheets may also be utilized. With metallic face sheets, and in some circumstances with prepreg, an adhesive film 9 is also used. Normally there are at least two prepreg skins on either side of the core

The honeycomb core of the present invention has cell walls of a resin impregnated fibrous nonwoven sheet with the planes of the cell walls preferably parallel to the T-dimension of the honeycomb. The nonwoven sheet apparent density before impregnation with resin is defined by the equation:

Dp=K×((dr×(100−%r)/%r)/(1+dr/ds×(100−%r)/%r)

where Dp is the apparent density of the nonwoven sheet before impregnation, dr is the density of cured resin, ds is the density of solid material in the nonwoven sheet before impregnation, % r is the cured resin content in the final core in weight %, and K is a number with a value from 1 to 1.35.

The high sheet material permeability and not very high apparent density allows good penetration of resin into the sheet material during the resin impregnation process such that the thickness of the sheet after coating is not significantly different from the uncoated nonwoven sheet thickness.

The nonwoven sheet before impregnation with resin has a Gurley air resistance not exceeding 30 seconds per 100 milliliters.

The free volume/void content in the nonwoven sheet can be measured based on apparent density of nonwoven sheet and density of solid materials in the nonwoven sheet or by image analysis of the nonwoven cross-section.

The thickness of the nonwoven sheet used in this invention is dependent upon the end use or desired properties of the honeycomb core and in some embodiments is typically from 3 to 20 mils (75 to 500 micrometers) thick. In some embodiments, the basis weight of the nonwoven sheet is from 0.5 to 6 ounces per square yard (15 to 200 grams per square meter).

The nonwoven sheet used in the honeycomb core of this invention comprises 70 to 100 parts by weight of a high modulus high strength fiber having an initial Young's modulus of at least 200 grams per denier (180 grams per dtex), a tenacity of at least 10 grams per denier (9 grams per dtex) and no more than 30 wt. % of a binder.

Different materials can be used as the nonwoven sheet binder depending on the final end-use. Preferable binders include poly (m-phenylene isophthalamide), poly (p-phenylene terephthalamide), polysulfonamide (PSA), poly-phenylene sulfide (PPS), and polyimides. Different high modulus high strength fibers in the form of the continuous fiber, cut fiber (floc), pulp or their combination can be used in the high modulus high strength fiber nonwoven sheet of the honeycomb core of this invention. Preferable types of fibers include p-aramid, liquid crystal polyester, polybenzazole, polypyridazole, polysulfonamide, polyphenylene sulfide, polyolefins, carbon, glass and other inorganic fibers or mixture thereof.

As employed herein the term aramid means a polyamide wherein at least 85% of the amide (—CONH—) linkages are attached directly to two aromatic rings. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. Para aramid fibers and various forms of these fibers are available from E. I. du Pont de Nemours and Company, Wilmington, Del. under the trademark Kevlar® and from Teijin, Ltd., under the trademark Twaron®. Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, both available from Toyobo Co. Inc., Osaka, Japan. Commercially available carbon fibers useful in this invention include Tenax® fibers available from Toho Tenax America, Inc, Rockwood, Tenn. Commercially available liquid crystal polyester fibers useful in this invention include Vectran® HS fiber available from Kuraray America Inc., New York, N.Y.

The nonwoven sheet of the honeycomb core structure of this invention can also include fibers of lower strength and modulus blended with the higher modulus fibers. The amount of lower strength fiber in the blend will vary on a case by case basis depending on the desired strength of the folded core structure. The higher the amount of low strength fiber, the lower will be the strength of the folded core structure. In a preferred embodiment, the amount of lower strength fiber should not exceed 30%. Examples of such lower strength fibers are meta-aramid fibers and poly (ethylene therephtalamide) fibers.

The nonwoven sheet of the honeycomb core of this invention can contain small amounts of inorganic particles and representative particles include mica, vermiculite, and the like; the addition of these performance enhancing additives being to impart properties such as improved fire resistance, thermal conductivity, dimensional stability, and the like to the nonwoven sheet and the final folded core structure.

The preferable type of the nonwoven sheet used for the honeycomb core of this invention is paper or wet-laid nonwoven. However, nonwovens made by other technologies including needle punching, adhesive bonding, thermal bonding, and hydroentangling can also be used.

The paper (wet-laid nonwoven) used to make the honeycomb core of this invention can be formed on equipment of any scale, from laboratory screens to commercial-sized papermaking machinery, including such commonly used machines as Fourdrinier or inclined wire paper machines. A typical process involves making a dispersion of fibrous material such as floc and/or pulp and a binder in an aqueous liquid, draining the liquid from the dispersion to yield a wet composition and drying the wet paper composition. The dispersion can be made either by dispersing the fibers and then adding the binder or by dispersing the binder and then adding the fibers. The final dispersion can also be made by combining a dispersion of fibers with a dispersion of the binder; the dispersion can optionally include other additives such as inorganic materials. The concentration of fibers in the dispersion can range from 0.01 to 1.0 weight percent based on the total weight of the dispersion. The concentration of the binder in the dispersion can be up to 30 weight percent based on the total weight of solids. In a typical process, the aqueous liquid of the dispersion is generally water, but may include various other materials such as pH-adjusting materials, forming aids, surfactants, defoamers and the like. The aqueous liquid is usually drained from the dispersion by conducting the dispersion onto a screen or other perforated support, retaining the dispersed solids and then passing the liquid to yield a wet paper composition. The wet composition, once formed on the support, is usually further dewatered by vacuum or other pressure forces and further dried by evaporating the remaining liquid.

In one preferred embodiment, the fiber and the polymeric binder can be slurried together to form a mix that is converted to paper on a wire screen or belt. Reference is made to U.S. Pat. Nos. 4,698,267 and 4,729,921 to Tokarsky; 5,026,456 to Hesler et al.; 5,223,094 and 5,314,742 to Kirayoglu et al for illustrative processes for forming papers from various types of fiber material and polymeric binders.

Once the paper is formed, it is calendered to the desired density or left uncalendered depending on the target final density.

In the latter case, some adjustments of density can be performed during forming by optimizing vacuum on the forming table and pressure in wet presses.

Floc is generally made by cutting continuous spun filaments into specific-length pieces. If the floc length is less than 2 millimeters, it is generally too short to provide a paper with adequate strength; if the floc length is more than 25 millimeters, it is very difficult to form uniform wet-laid webs. Floc having a diameter of less than 5 micrometers, and especially less than 3 micrometers, is difficult to produce with adequate cross sectional uniformity and reproducibility; if the floc diameter is more than 20 micrometers, it is very difficult to form uniform papers of light to medium basis weights.

The term “pulp”, as used herein, means particles of fibrous material having a stalk and fibrils extending generally therefrom, wherein the stalk is generally columnar and about 10 to 50 micrometers in diameter and the fibrils are fine, hair-like members generally attached to the stalk measuring only a fraction of a micrometer or a few micrometers in diameter and about 10 to 100 micrometers long. One possible illustrative process for making aramid pulp is generally disclosed in U.S. Pat. No. 5,084,136.

One of the preferred types of the binder for the wet-laid nonwoven of this invention is fibrids.

The term “fibrids” as used herein, means a very finely-divided polymer product of small, filmy, essentially two-dimensional particles having a length and width on the order of 100 to 1000 micrometers and a thickness on the order of 0.1 to 1 micrometer. Fibrids are typically made by streaming a polymer solution into a coagulating bath of liquid that is immiscible with the solvent of the solution. The stream of polymer solution is subjected to strenuous shearing forces and turbulence as the polymer is coagulated.

Preferable polymers for fibrids in this invention include aramids (poly (m-phenylene isophthalamide), poly (p-phenylene terephthalamide)).

Processes for converting the web substrates for honeycomb cell walls described above into honeycomb core are well known to those skilled in the art and include expansion and corrugation. The expansion process is particularly well suited for making flooring grade core. Such processes are further detailed on page 721 of the Engineered Materials Handbook, Volume 1—Composites, ASM International, 1988.

The honeycomb core of the present invention has a cured resin content of at least 62 wt. % of the total weight of sheet material plus cured resin coat. The resin impregnation on the nonwoven sheet may be applied before forming the honeycomb core shape or after core formation has been completed. A two stage impregnation process can also be used in which part of the resin is impregnated into the nonwoven sheet before shape forming and the balance impregnated after shape forming. When the resin impregnation of the nonwoven sheet is conducted prior to shape forming it is preferred that the resin is partially cured. Such a partial curing process, known as B-staging, is well known in the composite materials industry. By B-stage we mean an intermediate stage in the polymerization reaction in which the resin softens with heat and is plastic and fusible but does not entirely dissolve or fuse. The B-staged substrate is still capable of further processing into the desired honeycomb core shape.

When the resin impregnation is conducted after the core has been formed (expanded), it is normally done in a sequence of repeating steps of dipping followed by solvent removal and curing of the resin. The preferred final core densities (nonwoven sheet plus resin) are in the range of 20 to 150 kg/m³. During the resin impregnation process, resin is absorbed into and coated onto the cell walls.

Depending on the final application of the honeycomb core of this invention, different resins can be used to coat and impregnate the nonwoven sheet. Such resins include phenolic, epoxy, polyester, polyamide, and polyimide resins. Phenolic and polyimide resins are preferable. Phenolic resins normally comply with United States Military Specification MIL-R-9299C. Combinations of these resins may also be utilized. Suitable resins are available from companies such Hexion Specialty Chemicals, Columbus, Ohio or Durez Corporation, Detroit, Mi.

Honeycomb core of the above invention may be used to make composite panels having facesheets bonded to at least one exterior surface of the core structure. The facesheet material can be a plastic sheet or plate, a fiber reinforced plastic (prepreg) or metal. The facesheets are attached to the core structure under pressure and usually with heat by an adhesive film or from the resin in the prepreg. The curing is carried out in a press, an oven or an autoclave. Such techniques are well understood by those skilled in the art.

### Test Methods

Apparent Density of the nonwoven sheet was calculated using the nonwoven sheet thickness as measured by ASTM D645-97 at a pressure of about 50 kPa and the basis weight as measured by ASTM D646-96. Fiber denier was measured using ASTM D1907-07.

Gurley Air Resistance (porosity) for the nonwoven sheets was determined by measuring air resistance in seconds per 100 milliliters of cylinder displacement for approximately 6.4 square centimeters circular area of a paper using a pressure differential of 1.22 kPa in accordance with TAPPI T460.

Density of the honeycomb core was determined in accordance with ASTM C271-61.

Compression strength of the core was determined in accordance with ASTM C365-57.

Specific compression strength of the core was calculated by dividing compression strength values by the density of the core.

### EXAMPLES

### Example 1

A high modulus high strength fiber nonwoven sheet comprising 81 weight % p-aramid floc and 19 weight % meta-aramid fibrids was formed on conventional paper forming equipment. The para-aramid floc was Kevlar®49 having a nominal filament linear density of 1.5 denier per filament (1.7 dtex per filament), a 6.4 mm cut length, a tenacity of 24 grams per denier and a modulus of 960 grams per denier. Such fiber is available from E.I. DuPont de Nemours and Company, Wilmington, Del. The meta-aramid fibrids were prepared as described in U.S. Pat. No. 3,756,908 to Gross.

The nonwoven sheet was then calendered to produce the final sheet with an apparent density of 0.62 g/cm³, a basis weight 1.4 oz per square yard (47.5 grams per square meter) and a Gurley porosity of 4 seconds per 100 milliliters. The nonwoven sheet apparent density of 0.62 g/cm³ was targeted for the resin content of about 62-64 wt. % in the final core based on the equation:

Dp=K×((dr×(100−%r)/%r)/(1+dr/ds×(100−%r)/%r)

Where Dp is the apparent density of the nonwoven sheet before impregnation, dr is the density of cured resin (1.25 g/cm³), ds is the density of solid material in the nonwoven sheet before impregnation (1.4 g/cm³) % r is the matrix resin content in the final core in weight %, and K is a number with a value from 1.0 to 1.35.
A honeycomb block was formed from the paper of Example 1. Such a process is well known to those skilled in the art but is summarized in the following manner.

Node lines of adhesive resin were applied to the paper surface with the width of the lines of adhesive being 1.78 mm. The pitch, or the linear distance between the start of one line and the next line, is 5.3 mm. The adhesive was partially dried on the paper in an oven.

The sheet with the adhesive node lines was cut parallel to the node lines to form many smaller sheets. The cut sheets were stacked one on top of the other, such that each of the sheets was shifted to the other by half a pitch or a half the interval of the applied adhesive node lines. The shift occurred alternately to one side or the other, so that the final stack was uniformly vertical. The stack of sheets was then hot-pressed causing the node line adhesive to cure and thus bond adjacent sheets.

The bonded aramid sheets were then expanded in the direction counter to the stacking direction to form cells having an equilateral cross section. Each of the sheets were extended between each other such that the sheets are folded along the edges of the bonded node lines and the portions not bonded were extended in the direction of the tensile force to separate the sheets from each other.

After the expansion, the honeycomb block was heat treated in the oven to set it in the expanded shape.

The honeycomb block was then placed in an impregnating bath or dip tank containing a solution of phenolic resin complying with United States Military Specification MIL-R-9299C. After impregnating with resin, the honeycomb was taken out from the bath and was dried in a drying furnace using hot air. The dipping and curing steps were repeated 4 times. The final dipped and cured honeycomb with improved compression strength has a bulk density of about 104 kg m³.

The specific bare compression strength was 0.087 (N/mm2)/(kg/m3). The key data is summarized in Table 1.

### Comparative Example 1

A high modulus high strength fiber nonwoven sheet was formed as in Example 1, but calendered to an apparent density of 0.83 g/cm³. Final basis weight was about 1.2 oz per square yard (40.7 grams per square meter). The Gurley porosity of the sheet was about 5 seconds.

The nonwoven sheet was then converted into a honeycomb core structure as in Example 1.

The finished honeycomb core structure had a density of 97 kg/m3 and a resin content of 67% of the total core weight. The specific bare compression strength was 0.064 (N/mm2)/(kg/m3). The key data is summarized in Table 1.

TABLE 1

| | | | Range of | | Specific bare |
|---|---|---|---|---|---|
| | | | optimum | Apparent | compression |
| | Core | Resin | density of | density of | strength, |
| | density, | content, | nonwoven, | nonwoven, | (N/mm²)/ |
| Example | kg/m3 | wt. % | (g/cm³) | (g/cm³) | (kg/m³) |
| 1 | 104 | 64 | 0.47-0.63 | 0.62 | 0.087 |
| Comp. 1 | 97 | 67 | 0.43-0.58 | 0.83 | 0.064 |

As can be seen from the summary in Table 1, the honeycomb core structure of Example 1 having a nonwoven sheet optimized, in accordance with this invention, for apparent density and resin penetration in the honeycomb cell wall had a 35 percent higher specific bare compression strength in comparison with the honeycomb core structure from the prior art of Comparative Example 1. This confirms that the optimization of both the density of the nonwoven sheet used to make the honeycomb core structure and the resin content impregnated into the nonwoven sheet results in a significant improvement in compression strength.

What is claimed is:

1. A honeycomb core structure comprising:
(a) a plurality of interconnected walls having surfaces which define a plurality of honeycomb cells, wherein said cell walls are formed from a nonwoven sheet comprising fibers having a modulus of at least 200 grams per denier (180 grams per dtex) and a tenacity of at least 10 grams per denier (9 grams per dtex) wherein, prior to impregnation with a resin:
(1) said nonwoven sheet has an apparent density calculated from the equation Dp=K×((dr×(100−% r)/% r)/(1+dr/ds×(100−% r)/% r), where Dp is the apparent density of the nonwoven sheet before impregnation, dr is the density of cured resin, ds is the density of solid material in the nonwoven sheet before impregnation, % r is the cured resin content in the final core structure in weight %, K is a number with a value from 1.0 to 1.35
(2) said nonwoven sheet has a Gurley porosity of no greater than 30 seconds per 100 milliliters and
(b) a cured resin in an amount such that the weight of cured resin as a percentage of combined weight of cured resin and nonwoven sheet is at least 62 percent.

2. The core structure of claim 1 wherein the nonwoven sheet comprises 70-100 wt. % of fiber and 0-30 wt. % of a binder.

3. The core structure of claim 2 wherein the nonwoven sheet is a wet-laid nonwoven sheet

4. The core structure of claim 2 wherein the binder comprises m-aramid fibrids.

5. The core structure of claim 2 wherein the fiber comprises p-aramid fiber

6. A composite panel comprising a core structure according to any one of the preceding claims and at least one facesheet attached to at least one exterior surface of said core structure.

7. The structural panel according to claim 6, wherein said facesheet is made from resin impregnated fiber, plastic or metal.
